(19) United States
(12) Patent Application Publication
(10) Pub. No.: US 2014/0136565 A1
(43) Pub. Date: May 15, 2014

(54) SIMILAR CONTENTS SEARCHING APPARATUS BASED ON USER PREFERENCE AND SIMILAR CONTENTS SEARCHING METHOD THEREOF

(71) Applicant: Electronics and Telecommunications Research Institute, Daejeon-si (KR)

(72) Inventor: Hyung Woo KIM, Gyeonggi-do (KR)

(73) Assignee: Electronics and Telecommunications Research Institute, Daejeon-si (KR)

(21) Appl. No.: 13/925,099

(22) Filed: Jun. 24, 2013

(30) Foreign Application Priority Data
Nov. 12, 2012 (KR) 10-2012-0127588

(51) Int. Cl. G06F 17/30

(52) U.S. Cl. CPC G06F 17/30424
USPC 707/769

(57) ABSTRACT

A similar contents searching apparatus based on user preference and a similar contents searching method thereof are provided. The present invention searches similar contents based on user preference using user comments that are extracted from texts input as users' responses to contents, and provides the searched similar contents. Accordingly, a similar contents search result is good in quality, thus enhancing the reliability of search.

### CROSS-REFERENCE TO RELATED APPLICATION

This application claims the benefit under 35 U.S.C. §119(a) of a Korean Patent Application No. 10-2012-0127588, filed on Nov. 12, 2012, the entire disclosure of which is incorporated herein by reference for all purposes.

### BACKGROUND

1. Field

The following description relates to contents searching technology, and more particularly, to a similar contents searching apparatus based on user preference and a similar contents searching method thereof.

2. Description of the Related Art

Technology, which provides information on contents similar to contents that a user is searching over a web browser, is based on only simple information at present. For example, in multimedia contents such as movies, the technology simply provides similar contents using only metadata information of corresponding contents such as a different movie in which a leading actor appearing in a movie (which a user is viewing) appears in a main role, a different movie directed by the same director, a movie of the same genre, etc.

However, in desired information, users actually desire information of contents having features or details similar to those of specific contents, and, despite the same contents, different contents can be felt as similar contents due to a difference between user preferences. For this reason, there are ten thousands of questions that ask about “movie similar to A movie” and “movie equal to the A movie”, in the same search site, and many users have difficulties in finding similar contents.

Therefore, the inventor started to study a similar contents searching technology based on user preference which searches similar contents based on user preference using user comments that are extracted from texts input as users' responses to contents, and provides the searched similar contents.

### SUMMARY

The following description relates to a similar contents searching apparatus based on user preference and a similar contents searching method thereof, which search similar contents based on user preference using user comments that are extracted from texts input as users' responses to contents.

In one general aspect, a similar contents searching apparatus based on user preference includes: a user comment database (DB) configured to store user comments on contents; a user preference DB configured to store users' contents preferences; a contents feature extractor configured to search and analyze comments of similar users, having a contents preference similar to a user requesting search of similar contents searched from the user preference DB, from the user comment DB to extract a contents feature of original contents; a contents similarity calculator configured to search the user comment DB to select at least one similar contents having the contents feature extracted by the contents feature extractor, and calculate a similarity between the selected similar contents and the original contents for which search of similar contents has been requested; and a similar contents information provider configured to provide at least one piece of similar contents information in a descending order of the contents similarities calculated by the contents similarity calculator.

The contents feature extractor may include a user comment searching unit configured to search user comments on the original contents, for which search of similar contents has been requested, from the user comment DB, a similar user searching unit configured to search similar users, having a contents preference similar to a user requesting search of similar contents, from the user preference DB, a comment prioritizing unit configured to prioritize the user comments, searched by the user comment searching unit, in a preference order of the similar users searched by the similar user searching unit, and a contents feature deciding unit configured to decide at least one comment as a contents feature in a descending order of priorities among the comments prioritized by the comment prioritizing unit.

The similar contents searching apparatus may further include a user comment collector configured to collect texts input as users' responses to specific contents, morpheme-analyze the collected texts to extract word-unit user comments, and store the extracted user comments on corresponding contents in the user comment DB.

The user comment collector may be configured to give weights to the respective user comments based on frequency of extraction, number of sharings, number of retweetings, or a total sum mark.

The contents similarity calculator may be configured to vectorize a contents feature of the original contents and a contents feature of the similar contents, and calculate a contents similarity between the two contents-feature vectors as a value between 0 and 1 using a cosine similarity technique to calculate a similarity between the original contents and the selected similar contents.

The contents-feature vectors may be decided based on preferences of the user comments comprised in the contents feature.

The similar contents searching apparatus may further include a contents preference processor configured to analyze the user comments on contents stored in the user comment DB to extract users' comment features, calculate the users' contents preferences using the extracted users' comment features, and store the calculated contents preferences in the user preference DB.

The contents preference processor may be configured to analyze the user comments on contents stored in the user comment DB to vectorize the users' comment features, and to calculate a contents preference as a value between 0 and 1 using a cosine similarity technique.

The contents preference processor may be configured to group users having a similar contents preference, based on a distribution of the values between 0 and 1 calculated by the cosine similarity technique.

The user comment information stored in the user comment DB may include contents identification information, at least one user comment, and at least one piece of user identification information.

The user comment information stored in the user comment DB may further include a weight of each of the user comments.

The similar contents searching apparatus may further include a user input unit configured to provide a user interface for requesting search of similar contents, and receive a name of the original contents through the user interface to receive a similar contents search request for the original contents.

In another general aspect, a similar contents searching method of a similar contents searching apparatus based on user preference includes: receiving a name of original contents for searching similar contents; searching user comments on the original contents, for which search of similar contents has been requested, from a user comment DB; searching similar users, having a contents preference similar to a user who has requested the search of similar contents, from a user preference DB; prioritizing the searched user comments in a preference order of the searched similar users; extracting at least one comment as a contents feature from among the prioritized comments in a descending order of priorities; searching the user comment DB to select at least one similar contents having the extracted contents feature; calculating a similarity between the selected similar contents and the original contents for which search of similar contents has been requested; and providing at least one piece of similar contents information in a descending order of the calculated contents similarities.

The calculating of a similarity may include vectorizing a contents feature of the original contents and a contents feature of the similar contents, and calculating a contents similarity between the two contents-feature vectors as a value between 0 and 1 using a cosine similarity technique to calculate a similarity between the original contents and the selected similar contents.

The contents-feature vectors may be decided based on preferences of the user comments comprised in the contents feature.

The user comment information stored in the user comment DB may include contents identification information, at least one user comment, and at least one piece of user identification information.

The user comment information stored in the user comment DB may further include a weight of each of the user comments.

Other features and aspects will be apparent from the following detailed description, the drawings, and the claims.

### BRIEF DESCRIPTION OF THE DRAWINGS

FIG. 1 is a block diagram illustrating a configuration of an embodiment of a similar contents searching apparatus based on user preference according to the present invention.

FIG. 2 is a block diagram illustrating a configuration of an embodiment of a contents feature extractor of the similar contents searching apparatus based on user preference according to the present invention.

FIG. 3 is a flowchart illustrating an embodiment of a similar contents searching method of the similar contents searching apparatus based on user preference according to the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, the present invention will be described in detail such that those of ordinary skill in the art can easily understand and reproduce the present invention through embodiments which will be described below with reference to the accompanying drawings.

In the following description, when the detailed description of the relevant known function or configuration is determined to unnecessarily obscure the important point of the present invention, the detailed description will be omitted.

Terms used herein are terms that have been defined in consideration of functions in embodiments, and the terms that have been defined as described above may be altered according to the intent of a user or operator, or conventional practice, and thus, the terms should be defined on the basis of the entire content of this specification.

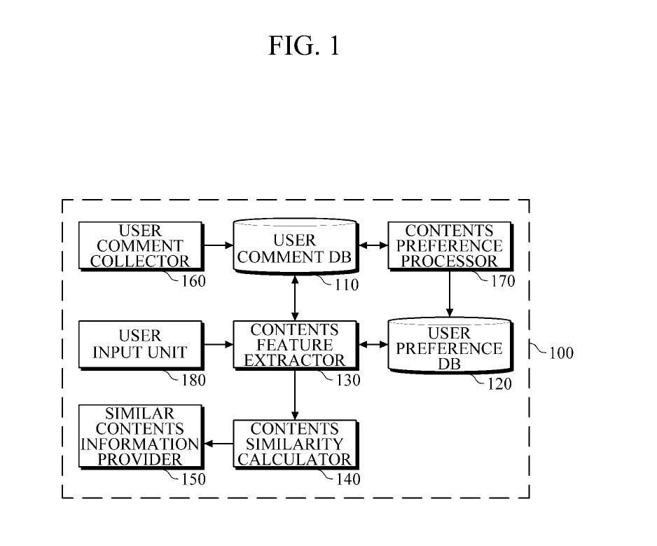

FIG. 1 is a block diagram illustrating a configuration of an embodiment of a similar contents searching apparatus based on user preference according to the present invention. As illustrated in FIG. 1, a similar contents searching apparatus 100 based on user preference according to an embodiment includes a user comment database (DB) 110, a user preference DB 120, a contents feature extractor 130, a contents similarity calculator 140, and a similar contents information provider 150.

The user comment DB 110 stores user comments on contents. For example, user comment information stored in the user comment DB 110 may include contents identification information, at least one user comment, at least one piece of user identification information, a comment input time, etc.

The user comment information stored in the user comment DB 110 may further include a weight of each user comment. For example, a weight of a user comment may be decided based on the frequency of extraction or a total sum mark in a case of a web board, decided based on the frequency of extraction or the number of sharings in a case of Facebook, and decided based on the frequency of extraction and the number of retweetings in a case of Twitter.

The user preference DB 120 stores users' contents preferences. Here, the contents preferences are information that is calculated using users' comment features which are extracted by analyzing the user comments on contents stored in the user comment DB 110.

The contents feature extractor 130 searches and analyzes comments of similar users, having a contents preference similar to that of a user requesting the search of similar contents searched from the user preference DB 120, from the user comment DB 110 to extract a contents feature of the original contents.

Here, the contents features include at least one user comment, which is able to specify the original contents, selected from among user comments which are extracted in units of a word by morpheme-analyzing texts input as users' responses to the original contents. For example, a user comment able to specify the original contents may be selected in a descending order of the frequency of extraction or a total sum mark in a case of a web board, selected in a descending order of the number of sharings in a case of Facebook, and selected in a descending order of the number of retweetings in a case of Twitter.

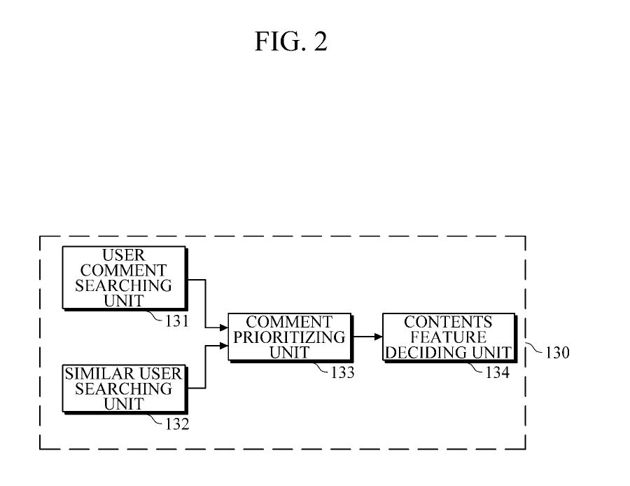

FIG. 2 is a block diagram illustrating a configuration of an embodiment of a contents feature extractor of the similar contents searching apparatus based on user preference according to the present invention. As illustrated in FIG. 2, the contents feature extractor 130 may include a user comment searching unit 131, a similar user searching unit 132, a comment prioritizing unit 133, and a contents feature deciding unit 134.

The user comment searching unit 131 searches user comments on the original contents, for which search of similar contents has been requested, from the user comment DB 110. When a similar contents search request for the specific original contents is received from a user equipment (not shown), the user comment searching unit 131 searches user comments, which are stored to be mapped to contents identification information of the original contents for which search of similar contents has been requested, from the user comment DB 110.

The similar user searching unit 132 searches similar users, having a contents preference similar to that of a user who has requested the search of similar contents, from the user preference DB 120. When a similar contents search request for the specific original contents is received from a user equipment (not shown), the similar user searching unit 132 searches users' preference information stored in the user preference DB 120 to search similar users having a contents preference similar to that of a user who has requested the search of similar contents.

The comment prioritizing unit 133 prioritizes user comments, searched by the user comment searching unit 131, in a preference order of similar users searched by the similar user searching unit 132.

For example, when the frequency of word extraction for user comments, which similar users have mentioned about the original contents “a” on a web board, is one hundred in “action”, eighty-three in “war”, seventy-seven in “antiwar”, and fifty-eight in “sensation”, the comment prioritizing unit 133 may grade priorities in the order of “action”, “war”, “antiwar”, and “sensation”. Also, a mark of a user comment in which words emerge may be reflected in calculating priorities.

For example, when the frequency of word emergence in postings, which similar users have posted about the original contents “a” on Facebook, is one hundred in “action”, eighty-three in “war”, seventy-seven in “antiwar”, and fifty-eight in “sensation”, the comment prioritizing unit 133 may grade priorities in the order of “action”, “war”, “antiwar”, and “sensation”. Also, the number of sharings of postings and the number of postings “good” may be reflected in grading priorities.

For example, when the frequency of extraction of words, which similar users have mentioned about the original contents “a” on Twitter, is one hundred in “action”, eighty-three in “war”, seventy-seven in “antiwar”, and fifty-eight in “sensation”, the comment prioritizing unit 133 may grade priorities in the order of “action”, “war”, “antiwar”, and “sensation”. Also, the number of retweetings of a tweet, in which corresponding words emerge, and the number of followers of a writer may be reflected in grading priorities.

The contents feature deciding unit 134 decides at least one comment as a contents feature in a descending order of priorities among comments prioritized by the comment prioritizing unit 133. For example, when user comments on the original contents “a” (which are movie contents) are prioritized in the order of “action”, “war”, “antiwar”, and “sensation” by the comment prioritizing unit 133, the contents feature deciding unit 134 may decide “action” and “war” as contents features of corresponding original contents. Here, the number of comments decided as contents features by the contents feature deciding unit 134 may be set as a specific number.

The contents similarity calculator 140 searches the user comment DB 110 to select at least one similar contents having a contents feature extracted by the contents feature extractor 130, and calculates a similarity between the selected similar contents and the original contents for which search of similar contents has been requested.

For example, the contents similarity calculator 140 may vectorize a contents feature of the original contents and a contents feature of similar contents, and calculate a contents similarity between the two contents-feature vectors as a value between 0 and 1 using a cosine similarity technique, thereby calculating a similarity between the original contents and the selected similar contents.

In this case, a contents feature vector may be decided based on preferences of user comments included in the contents features. The preferences of user comments may be calculated based on the frequency of extraction or a total sum mark in a case of a web board, calculated based on the frequency of extraction or the number of sharings in a case of Facebook, and calculated based on the frequency of extraction and the number of retweetings in a case of Twitter.

That is, preference factors included in a contents feature may be extracted to have a weight in consideration of the frequency of extraction and a characteristic of a source medium which extracts a factor. The cosine similarity technique is a well-known software algorithm that is commonly used in calculating a word similarity.

The similar contents information provider 150 provides at least one piece of similar contents information in a descending order of contents similarities calculated by the contents similarity calculator 140. By such an implementation, when a user equipment (not shown) accessing the similar contents searching apparatus 100 based on user preference requests the search of similar contents of the specific original contents, the present invention searches similar contents based on user preference using user comments that are extracted from texts input as users' responses to contents, and provides the searched similar contents. Accordingly, a similar contents search result is good in quality, thus enhancing the reliability of search.

According to another aspect of the present invention, the similar contents searching apparatus 100 based on user preference may further include a user comment collector 160. The user comment collector 160 collects texts input as users' responses to specific contents from a social network such as a web board, Facebook, or Twitter, morpheme-analyzes the collected texts to extract word-unit user comments, and stores the extracted user comments on corresponding contents in the user comment DB 110.

At this time, the user comment collector 160 may give weights to the respective user comments based on the frequency of extraction or a total sum mark in a case of a web board, based on the number of sharings of user comments in a case of Facebook, and based on the number of retweetings of user comments in a case of Twitter.

That is, in the embodiment, new contents are continuously generated, and comments on contents (on which a user comment is already stored) increase with time, whereby the user comment collector 160 collects comments on the new contents or collects additional comments on contents (on which a comment is already registered) to store the collected comments in the user comment DB 110.

According to another aspect of the present invention, the similar contents searching apparatus 100 based on user preference may further include a contents preference processor 170. The contents preference processor 170 analyzes the user comments on contents stored in the user comment DB 110 to extract users' comment features, and calculates the users' contents preferences using the extracted users' comment features to store the calculated contents preferences in the user preference DB 120.

For example, the contents preference processor 170 may analyze the user comments on contents stored in the user comment DB 110 to vectorize the users' comment features, and calculate a contents preference as a value between 0 and 1 using the cosine similarity technique.

The contents preference processor 170 may group users having a similar contents preference, based on a distribution of values between 0 and 1 calculated by the cosine similarity technique.

That is, in the embodiment, new users are continuously added, and contents preferences of users (of which contents preferences are already calculated) are changed with time, whereby the contents preference processor 170 calculates the new users' contents preferences or the existing users' changed contents preferences to store the calculated contents preferences in the user preference DB 120.

According to another aspect of the present invention, the similar contents searching apparatus 100 based on user preference may further include a user input unit 180. The user input unit 180 provides a user interface for requesting the search of similar contents and receives a name of the original contents through the user interface to receive a similar contents search request for the original contents.

A user, desiring to search similar contents of the original contents, accesses the similar contents searching apparatus 100 based on user preference using a user equipment (not shown), and inputs a name of the original contents through the user interface provided by the user input unit 180.

Then, the user input unit 180 receives the similar contents search request for the original contents, and generates a command in order for the contents feature extractor 130 to extract a contents feature of the original contents for which the search of similar contents has been requested.

Therefore, the contents feature extractor 130 searches and analyzes comments of similar users, having a contents preference (searched from the user preference DB 120) similar to that of the user requesting the search of similar contents, from the user comment DB 110 to extract a contents feature of the original contents.

Furthermore, the contents similarity calculator 140 searches the user comment DB 110 to select at least one similar contents having the contents feature extracted by the contents feature extractor 130, calculates a similarity between the selected similar contents and the original contents for which the search of similar contents has been requested, and provides at least one piece of similar contents information to the user equipment in a descending order of contents similarities through the similar contents information provider 150.

As described above, the present invention searches similar contents based on user preference using user comments on the original contents and provides the searched similar contents. Accordingly, a similar contents search result is good in quality, thus enhancing the reliability of search.

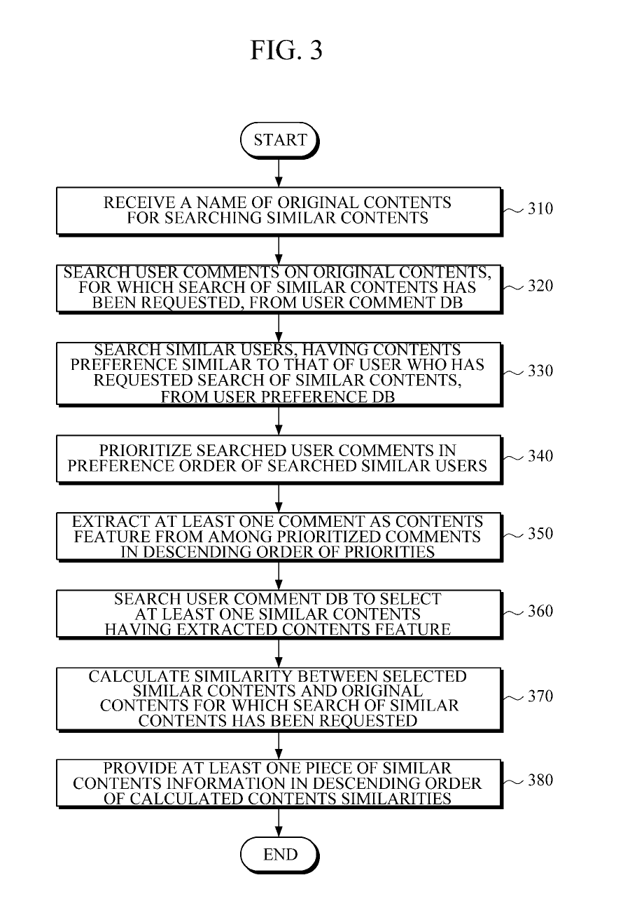

The above-described similar contents searching operation of the similar contents searching apparatus based on user preference according to the present invention will now be described in detail with reference to FIG. 3. FIG. 3 is a flowchart illustrating an embodiment of a similar contents searching method of the similar contents searching apparatus based on user preference according to the present invention.

First, in operation 310, the similar contents searching apparatus based on user preference receives a name of the original contents for searching similar contents. A user input for searching similar contents has been described above, and thus, a repetitive description is not provided.

Subsequently, in operation 320, the similar contents searching apparatus based on user preference searches user comments on the original contents, for which search of similar contents has been requested, from the user comment DB. Searching the user comments on the original contents has been described above, and thus, a repetitive description is not provided.

Here, user comment information searched from the user comment DB may include contents identification information, at least one user comment, and at least one piece of user identification information. Also, the user comment information searched from the user comment DB may further include a weight of each user comment.

Subsequently, in operation 330, the similar contents searching apparatus based on user preference searches similar users, having a contents preference similar to that of a user who has requested the search of similar contents, from the user preference DB. Searching similar users, having a contents preference similar to that of a user who has requested the search of similar contents, has been described above, and thus, a repetitive description is not provided.

In operation 340, the similar contents searching apparatus based on user preference prioritizes the searched user comments in a preference order of the searched similar users. Prioritizing the user comments has been described above, and thus, a repetitive description is not provided.

Subsequently, in operation 350, the similar contents searching apparatus based on user preference extracts at least one comment as a contents feature from among the prioritized comments in a descending order of priorities. Extracting the contents feature has been described above, and thus, a repetitive description is not provided.

Subsequently, in operation 360, the similar contents searching apparatus based on user preference searches the user comment DB to select at least one similar contents having the extracted contents feature.

Subsequently, in operation 370, the similar contents searching apparatus based on user preference calculates a similarity between the selected similar contents and the original contents for which search of similar contents has been requested. At this time, the similar contents searching apparatus based on user preference may vectorize a contents feature of the original contents and a contents feature of similar contents and calculate a contents similarity between the two contents-features vectors as a value between 0 and 1 using the cosine similarity technique, thereby calculating a similarity between the original contents and the selected similar contents.

The contents-feature vectors may be decided based on the frequency of extraction of user comments included in a contents feature. Selecting the similar contents and calculating the similarity have been described above, and thus, a repetitive description is not provided.

Subsequently, in operation 380, the similar contents searching apparatus based on user preference provides at least one piece of similar contents information in a descending order of the calculated contents similarities. By such an implementation, the present invention searches similar contents based on user preference using user comments that are extracted from texts input as users' responses to contents, and provides the searched similar contents. Therefore, a similar contents search result is good in quality, thus enhancing the reliability of search. Accordingly, the above-proposed objects of the present invention can be achieved.

As described above, the present invention searches similar contents based on user preference using user comments that are extracted from texts input as users' responses to contents, and provides the searched similar contents. Accordingly, a similar contents search result is good in quality, thus enhancing the reliability of search.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A similar contents searching apparatus based on user preference, comprising:
a user comment database (DB) configured to store user comments on contents;
s a user preference DB configured to store users' contents preferences;
a contents feature extractor configured to search and analyze comments of similar users, having a contents preference similar to a user requesting search of similar contents searched from the user preference DB, from the user comment DB to extract a contents feature of original contents;
a contents similarity calculator configured to search the user comment DB to select at least one similar contents having the contents feature extracted by the contents feature extractor, and calculate a similarity between the selected similar contents and the original contents for which search of similar contents has been requested; and
a similar contents information provider configured to provide at least one piece of similar contents information in a descending order of the contents similarities calculated by the contents similarity calculator.

2. The similar contents searching apparatus of claim 1, wherein the contents feature extractor comprises:
a user comment searching unit configured to search user comments on the original contents, for which search of similar contents has been requested, from the user comment DB;
a similar user searching unit configured to search similar users, having a contents preference similar to a user requesting search of similar contents, from the user preference DB;
a comment prioritizing unit configured to prioritize the user comments, searched by the user comment searching unit, in a preference order of the similar users searched by the similar user searching unit; and
a contents feature deciding unit configured to decide at least one comment as a contents feature in a descending order of priorities among the comments prioritized by the comment prioritizing unit.

3. The similar contents searching apparatus of claim 1, further comprising a user comment collector configured to collect texts input as users' responses to specific contents, morpheme-analyze the collected texts to extract word-unit user comments, and store the extracted user comments on corresponding contents in the user comment DB.

4. The similar contents searching apparatus of claim 3, wherein the user comment collector is configured to give weights to the respective user comments based on frequency of extraction, number of sharings, number of retweetings, or a total sum mark.

5. The similar contents searching apparatus of claim 4, wherein the contents similarity calculator is configured to vectorize a contents feature of the original contents and a contents feature of the similar contents, and calculate a contents similarity between the two contents-feature vectors as a value between 0 and 1 using a cosine similarity technique to calculate a similarity between the original contents and the selected similar contents.

6. The similar contents searching apparatus of claim 5, wherein the contents-feature vectors are decided based on preferences of the user comments comprised in the contents feature.

7. The similar contents searching apparatus of claim 1, further comprising a contents preference processor configured to analyze the user comments on contents stored in the user comment DB to extract users' comment features, calculate the users' contents preferences using the extracted users' comment features, and store the calculated contents preferences in the user preference DB.

8. The similar contents searching apparatus of claim 7, wherein the contents preference processor is configured to analyze the user comments on contents stored in the user comment DB to vectorize the users' comment features, and to calculate a contents preference as a value between 0 and 1 using a cosine similarity technique.

9. The similar contents searching apparatus of claim 8, wherein the contents preference processor is configured to group users having a similar contents preference, based on a distribution of the values between 0 and 1 calculated by the cosine similarity technique.

10. The similar contents searching apparatus of claim 1, wherein the user comment information stored in the user comment DB comprises contents identification information, at least one user comment, and at least one piece of user identification information.

11. The similar contents searching apparatus of claim 10, wherein the user comment information stored in the user comment DB further comprises a weight of each of the user comments.

12. The similar contents searching apparatus of claim 1, further comprising a user input unit configured to provide a user interface for requesting search of similar contents, and receive a name of the original contents through the user interface to receive a similar contents search request for the original contents.

13. A similar contents searching method of a similar contents searching apparatus based on user preference, comprising:
receiving a name of original contents for searching similar contents;
searching user comments on the original contents, for which search of similar contents has been requested, from a user comment database (DB);
searching similar users, having a contents preference similar to a user who has requested the search of similar contents, from a user preference DB;
prioritizing the searched user comments in a preference order of the searched similar users;
extracting at least one comment as a contents feature from among the prioritized comments in a descending order of priorities;
searching the user comment DB to select at least one similar contents having the extracted contents feature;
calculating a similarity between the selected similar contents and the original contents for which search of similar contents has been requested; and
providing at least one piece of similar contents information in a descending order of the calculated contents similarities.

14. The similar contents searching method of claim 13, wherein the calculating of a similarity comprises vectorizing a contents feature of the original contents and a contents feature of the similar contents, and calculating a contents similarity between the two contents-feature vectors as a value between 0 and 1 using a cosine similarity technique to calculate a similarity between the original contents and the selected similar contents.

15. The similar contents searching method of claim 14, wherein the contents-feature vectors are decided based on preferences of the user comments comprised in the contents feature.

16. The similar contents searching method of claim 13, wherein the user comment information stored in the user comment DB comprises contents identification information, at least one user comment, and at least one piece of user identification information.

17. The similar contents searching method of claim 16, wherein the user comment information stored in the user comment DB further comprises a weight of each of the user comments.
